(19) United States
(12) Patent Application Publication
(10) Pub. No.: US 2014/0070633 A1
(43) Pub. Date: Mar. 13, 2014

(54) LINEAR VIBRATOR

(71) Applicant: SAMSUNG ELECTRO-MECHANICS CO., LTD., Gyunggi-do (KR)

(72) Inventor: Yong-Jin KIM, Gyunggi-do (KR)

(73) Assignee: SAMSUNG ELECTRO-MECHANICS CO., LTD., Gyunggi-do (KR)

(21) Appl. No.: 13/678,041

(22) Filed: Nov. 15, 2012

(30) Foreign Application Priority Data
Sep. 7, 2012 (KR) 10-2012-0099518

(51) Int. Cl. H02K 33/18

(52) U.S. Cl. CPC H02K 33/18
USPC 310/25

(57) ABSTRACT

There is provided a linear vibrator including: a fixed part having an internal space of a predetermined size provided therein; a magnet coupled to one surface of the internal space of the fixed part and generating magnetic force; a vibrating part including a coil disposed to face the magnet and interacting with the magnet to generate electromagnetic force and a mass body vibrated by the electromagnetic force; and a holder provided between the coil and the mass body and having one edge and the other edge extended in an inner radial direction.

### CROSS-REFERENCE TO RELATED APPLICATIONS

This application claims the priority of Korean Patent Application No. 10-2012-0099518 filed on Sep. 7, 2012, in the Korean Intellectual Property Office, the disclosure of which is incorporated herein by reference.

### BACKGROUND OF THE INVENTION

1. Field of the Invention

The present invention relates to a linear vibrator, and more particularly, to a linear vibrator capable of being mounted in a portable electronic device for use as a silent call reception signal generating device.

2. Description of the Related Art

Recently, as the release of personal digital assistants having a large liquid crystal display (LCD) screen for user convenience has rapidly increased, a touchscreen scheme has been adopted and a vibration motor for generating vibrations at the time of a touchscreen touch has been used.

The vibration motor, a component converting electrical energy into mechanical vibrations using the principle of the generation of electromagnetic force, is mounted in the personal digital assistant to thereby be used for silently notifying a user of call reception by transferring vibrations thereto.

According to the related art, a scheme of obtaining mechanical vibrations by rotating a rotor part having an unbalanced mass using rotating force has been used. In this scheme, the rotating force is converted into mechanical vibrations by a rectifying action through a contact point between a brush and a commutator.

However, in a brush type structure using the commutator, since the brush passes through a clearance between segments of the commutator at the time of rotation of the motor, mechanical friction and electrical sparks may be caused and foreign materials may be generated, such that a lifespan of the motor may be reduced.

In addition, since there may be a delay in arriving at a target vibration amount due to rotational inertia at the time of the application of voltage to the motor, implementing an appropriate amount of vibrations in a touchscreen may be problematic.

In order to overcome disadvantages of the lifespan and response speed characteristics of the motor, a linear vibrator has mainly been used to implement a vibration function in a touchscreen.

The linear vibrator does not use the rotational principle of the motor, but uses a principle in which electromagnetic force is periodically generated according to a resonance frequency to cause resonance such that a spring installed therein and a mass body suspended from the spring are moved, thereby generating vibrations.

### SUMMARY OF THE INVENTION

An aspect of the present invention provides a linear vibrator capable of increasing electromagnetic force to improve a vibration response speed and implementing an electromagnetic damping effect.

According to an aspect of the present invention, there is provided a linear vibrator including: a fixed part having an internal space of a predetermined size provided therein; a magnet coupled to one surface of the internal space of the fixed part and generating magnetic force; a vibrating part including a coil disposed to face the magnet and interacting with the magnet to generate electromagnetic force and a mass body vibrated by the electromagnetic force; and a holder provided between the coil and the mass body and having one edge and the other edge extended in an inner radial direction.

The holder may include: a cylindrical vertical part contacting one surfaces of the coil and the mass body; an upper horizontal part extended from one edge of the vertical part in the inner radial direction; and a lower horizontal part extended from the other edge of the vertical part in the inner radial direction.

The upper horizontal part may contact an upper surface of the coil, and the lower horizontal part may contact a lower surface of the coil.

The linear vibrator may further include a yoke plate coupled to a lower surface of the magnet and smoothing magnetic flux flowing to the magnet.

One surface of the internal space of the fixed part may be provided with an outer wall protruding therefrom so as to correspond to an outer diameter of the magnet.

The linear vibrator may further include a magnetic body coupled to the other surface of the internal space of the fixed part.

The other surface of the internal space of the fixed part may be provided with a protrusion part protruding therefrom so as to correspond to an outer diameter of the magnetic body.

The holder may be formed of a magnetic material.

According to another aspect of the present invention, there is provided a linear vibrator including: a fixed part having an internal space of a predetermined size provided therein; a magnet coupled to one surface of the internal space of the fixed part and generating magnetic force; a vibrating part including a coil disposed to face the magnet and interacting with the magnet to generate electromagnetic force and a mass body vibrated by the electromagnetic force; and a holder provided between the coil and the mass body and having one edge and the other edge extended in an inner radial direction and an outer radial direction.

The holder may include: a cylindrical vertical part contacting one surfaces of the coil and the mass body; an upper horizontal part extended from one edge of the vertical part in the inner radial direction and the outer radial direction; and a lower horizontal part extended from the other edge of the vertical part in the inner radial direction and the outer radial direction.

The upper horizontal part may contact an upper surface of the coil and an upper surface of the mass body, and the lower horizontal part may contact a lower surface of the coil and a lower surface of the mass body.

The holder may be formed of a magnetic material.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic exploded perspective view showing a linear vibrator according to an embodiment of the present invention;

FIG. 2 is a schematic cross-sectional view showing the linear vibrator according to the embodiment of the present invention;

FIG. 3 is a cross-sectional perspective view of a holder provided in the linear vibrator according to the embodiment of the present invention;

FIG. 4 is a cross-sectional perspective view of a holder provided in a linear vibrator according to another embodiment of the present invention;

FIG. 5 is a cross-sectional view showing an increase in electromagnetic force of the linear vibrator according to the embodiment of the present invention; and

FIG. 6 is a cross-sectional view showing an increase in electromagnetic force of the linear vibrator according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of components maybe exaggerated for clarity, and the same reference numerals will be used throughout to designate the same or like components.

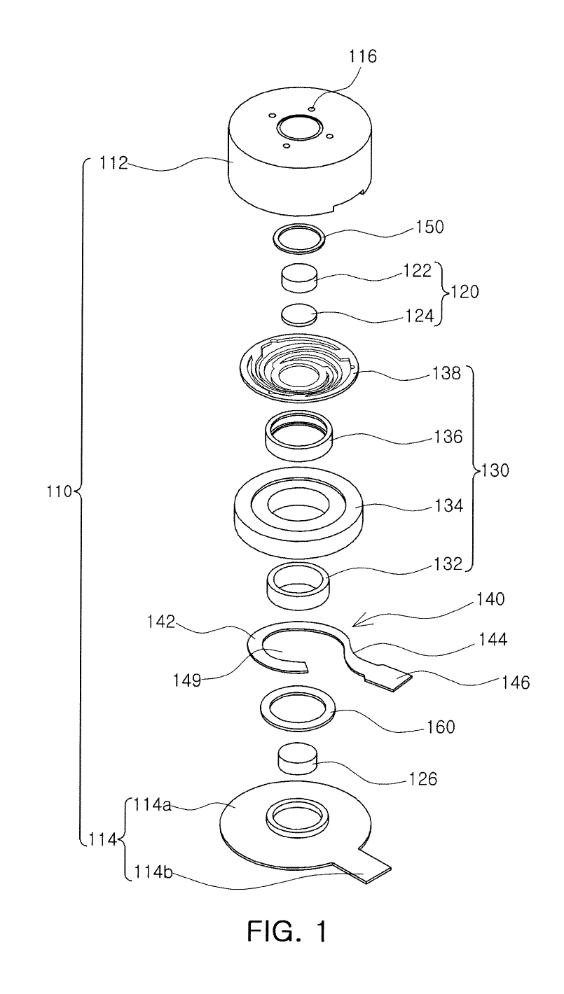

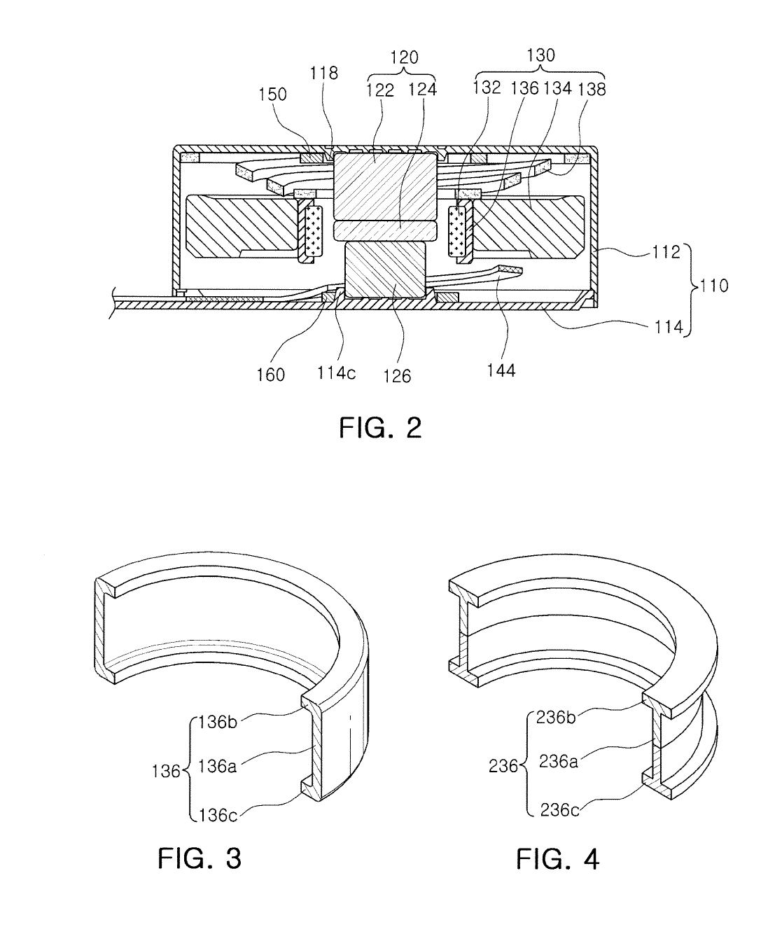

FIG. 1 is a schematic exploded perspective view showing a linear vibrator according to an embodiment of the present invention; and FIG. 2 is a schematic cross-sectional view showing the linear vibrator according to the embodiment of the present invention.

Terms with respect to directions will first be defined. An outer radial direction or an inner radial direction refers to a direction from the center of a case 112 toward an outer surface of the case 112 or vice versa. In addition, a circumferential direction refers to a direction running along the circumference of the case 112 (including both a clockwise direction and a counterclockwise direction).

Referring to FIGS. 1 to 2, a linear vibrator 100 according to the embodiment of the present invention may include a fixed part 110 forming outer casing of the linear vibrator 100, a magnetic field generating part 120, a vibrating part 130, and a substrate 140.

The fixed part 110 may include a case 112 open on one side thereof and providing a predetermined internal space therein and a bracket 114 coupled to the open one side of the case 112 to enclose the internal space formed by the case 112.

Here, the internal space may accommodate the magnetic field generating part 120 including a magnet 122 and the vibrating part 130 therein, and the case 112 and the bracket 114 may also be formed integrally with each other.

In addition, the case 112 may include at least one introduction hole 116 formed in an upper surface thereof.

The introduction hole 116 may be a hole through which a laser beam, required in the case in which an elastic member 138 and a holder 136 of the vibrating part 130 are coupled to each other, that is, in the case in which the elastic member 138 and the holder 136 are coupled to each other by welding, penetrates.

Here, the bracket 114 may include a closing part 114a closing the open one side of the case 112 and an extension part 114b protruding outwardly of the case 112 after the bracket 114 and the case 112 are coupled to each other.

In addition, the closing part 114a may be provided with a protrusion part 114c protruding from the closing part 114a so as to correspond to an outer diameter of a magnetic body 126.

An outer peripheral surface of the magnetic body 126 is inserted into and fixed to an inner surface of the protrusion part 114c, such that the magnetic body 126 may be more firmly coupled to the bracket 114.

Here, the magnetic body 126 may be disposed under the magnet 122 and a yoke plate 124 to prevent the magnet 122 from being separated from the case 112 due to an external impact, or the like.

The magnet 122 together with the yoke plate 124 may constitute the magnetic field generating part 120 of the linear vibrator 100 according to the embodiment of the present invention and be coupled to one surface of the internal space of the fixed part.

More specifically, the magnet 122 maybe coupled to one surface of the internal space of the case 112 by at least one of a bonding method, a press-fitting method, and a welding method.

The magnet 122 may have an outer diameter smaller than an inner diameter of a coil 132 coupled to the holder 136 and may be coupled to the case 112 to serve as a fixed member.

Here, an upper surface of the internal space of the case 112 maybe provided with an outer wall 118 protruding therefrom so as to correspond to the outer diameter of the magnet 122. An outer peripheral surface of the magnet 122 is inserted into and fixed to an inner surface of the outer wall 118, whereby the magnet 122 may be more firmly coupled to the case 112.

The magnet 122 and the magnetic body 126 may be cylindrical permanent magnets generating magnetic force having a predetermined strength by allowing upper and lower portions thereof to be magnetized with different magnetic polarities in a vertical direction to generate magnetic fields.

In addition, the magnet 122 and the magnetic body 126 may be positioned so that portions thereof having the same polarity face each other in order to generate the magnetic force.

Since the magnet 122 and the magnetic body 126 are disposed so that the portions thereof having the same polarity face each other, lines of magnetic force present between the magnet 122 and the magnetic body 126 are spread in an outer radial direction, such that magnetic efficiency may be increased and magnetic force may be particularly concentrated on a point at which the coil 132 positioned outwardly of the magnet 122 and the magnetic body 126 interlink with the lines of magnetic force. Therefore, when the same amount of current is consumed in the same volume, electromagnetic force maybe increased and a larger amount of vibrations may be implemented, as compared with the case in which a single magnet is used.

The magnet 122 may include the yoke plate 124 coupled to a lower surface thereof in order to form smooth magnetic flux flowing to the magnet 122 through the coil 132 interacting with the magnet 122 to generate electromagnetic force.

The yoke plate 124 may be formed of a magnetic material.

The vibrating part 130 may include the coil 132, a mass body 134, and the holder 136, and the coil 132 and the mass body 134 may be fixed using the holder 136, and vibrations may be transferred through the elastic member 138.

That is, the vibrating part 130 may be vibrated vertically relative to the fixed part through the elastic member 138.

Here, the inner diameter of the coil 132 may be larger than the outer diameter of the magnet 122.

More specifically, the coil 132 maybe disposed to face the magnet 122, and at least a portion of the magnet 122 may be inserted into a space formed by the coil 132.

Therefore, during movement of the vibrating part 130, the coil 132 and the magnet 122 may be maintained in a state of non-contact.

In addition, the coil 132 may be coupled to a hollow inner peripheral surface of the holder 136 and induce a magnetic field in the vicinity thereof when it has current having a predetermined frequency applied thereto.

In this case, when electromagnetic force is exerted by the coil 132, magnetic flux passes from the magnet 122 through the coil 132 in a horizontal direction, and the magnetic field is generated in a vertical direction by the coil 132, such that the vibrating part 130 may vibrate in the vertical direction.

Therefore, a magnetic flux direction of the magnet 122 and a vibration direction of the vibrating part 130 may be perpendicular to each other.

That is, when electromagnetic force having the same frequency as a natural mechanical frequency of the vibrating part 130 is exerted, resonance vibrations are generated in the vibrating part 130, such that a maximum vibration amount may be obtained, wherein the natural frequency of the vibrating part 130 is affected by the mass of the vibrating part 130 and an elastic modulus of the elastic member 138.

Here, the current applied to the coil 132 of the vibrating part 130, that is, external power having a predetermined frequency, may be provided through the substrate 140 coupled to the vibrating part 130, which will be described below.

The holder 136 may have the coil 132 coupled to an inner peripheral surface thereof and the mass body 134 coupled to an outer peripheral surface thereof to fixedly support the coil 132 and the mass body 134 and may be formed to have a hollow cylindrical shape in which upper and lower portions thereof are open.

The mass body 134, a vibrator body coupled to an outer peripheral surface of a vertical part 136a of the holder 136 to thereby vibrate vertically, may have an outer diameter smaller than an inner diameter of an inner peripheral surface of the case 112 so that it may vibrate without contacting the fixed part 110 within the fixed part 110 in the case in which it vibrates vertically.

Therefore, a clearance having a predetermined size may be formed between the inner peripheral surface of the case 112 and an outer peripheral surface of the mass body 134.

The mass body 134 may be formed of a non-magnetic material or a paramagnetic material that is not affected by the magnetic force generated by the magnet 122.

Therefore, the mass body 134 may be formed of a material such as tungsten having specific gravity higher than that of iron, to increase mass of the vibrating part 130 while retaining the same volume thereof to adjust a resonance frequency, thereby significantly increasing a vibration amount.

However, the mass body 134 is not limited to being formed of tungsten, but may also be formed of various materials according to a designer's intentions.

Here, in order to correct a natural frequency of the linear vibrator 100, the mass body 134 may be provided with a space into which a sub mass body may be additionally inserted, such that mass of the mass body 134 may be increased or decreased.

The elastic member 138 is a member coupled to the holder 136 and the case 112 as described above to provide elastic force thereto. An elastic modulus of the elastic member 138 has an effect on a natural frequency of the vibrating part 130.

Here, the elastic member 138 may be any one of a coil spring and a leaf spring. However, the elastic member 138 is not limited thereto, but may be any member capable of providing elastic force.

The substrate 140 may be coupled to one surface of the mass body 134 configuring the vibrating part 130 and include a through hole 149 allowing the magnet 122 passing therethrough to avoid contact with the magnet 122 at the time of the vibration of the vibrating part 130.

That is, the through hole 149 may prevent contact between the magnet 122 and the substrate 140 and allow an amplitude not to be limited at the time of the vibration and the movement of the vibrating part 130 to secure as large a vibration amount in the vibrating part 130 as possible.

Therefore, the linear vibrator 100 according to the embodiment of the present invention may obtain more stable linear vibrations due to the through hole 149.

More specifically, one end of the substrate 140 maybe coupled to the vibrating part 130 to thereby be a free end, and the other end thereof maybe coupled to the extension part 114b of the bracket 114 to thereby be a fixed end.

Here, the substrate 140 will be described in detail. The substrate 140 may be a flexible printed circuit board and may include a moving piece 142 coupled to the mass body 134 of the vibrating part 130, a fixed piece 146 coupled to the extension part 114b of the bracket 114, and a connecting piece 144 connecting the moving piece 142 and the fixed piece 146 to each other.

The moving piece 142, vibrating together with the vibrating part 130, may be a free end, and an upper surface of the moving piece 142 may contact a lower surface of the mass body 134 and they may be coupled to each other.

In addition, an internal space formed by the moving piece 142 is the through hole 149 described above.

The fixed piece 146 may include a power connection terminal (not shown) provided on an upper surface thereof in order to supply power to the coil 132, and may be protruded outwardly of the case 112.

Therefore, the fixed piece 146 of the substrate 140 may be coupled to the extension part 114b.

In addition, the substrate 140 may include the connecting piece 144 connecting the moving piece 142 and the fixed piece 146 to each other, and the connecting piece 144 may be swung from an end portion of the fixed piece 146 in the circumferential direction of the moving piece 142 in a state in which it is spaced apart from an edge of the moving piece 142 by a predetermined interval to allow the moving piece 142 to vibrate vertically.

In addition, the substrate 140 may include an electrode pad (not shown) provided on a lower surface thereof in order to transfer an electrical signal having a specific frequency to the coil 132, and the electrode pad may be electrically connected to a lead wire of the coil 132.

Here, the electrode pad may be formed outwardly of an outer diameter of the coil 132 and may be electrically connected to one edge of the lead wire of the coil 132 by soldering.

In other words, the electrode pad may be formed on a lower surface of the moving piece 142 of the substrate 140 and be connected to the lead wire of the coil 132.

Therefore, the lead wire of the coil 132 maybe connected to the electrode pad of the substrate 140 outwardly of the coil 132, such that it does not affect the vibration and the movement of the linear vibrator 100 according to the embodiment of the present invention when the linear vibrator 100 operates.

In order to prevent the generation of noise due to contact between the vibrating part 130 and the fixed part 110 during a vibrating process of the vibrating part 130, the case 112 may be provided with an upper damper 150 and the bracket 114 may be provided with a lower damper 160.

The upper damper 150 may be disposed outwardly of the outer wall 118 in one surface of the internal space of the case 112, and the lower damper 114 maybe disposed outwardly of the protrusion part 114c of the bracket 114.

FIG. 3 is a cross-sectional perspective view of a holder provided in the linear vibrator according to the embodiment of the present invention.

Referring to FIG. 3, the holder 136 may include a cylindrical vertical part 136a contacting one surfaces of the coil 132 and the mass body 134, an upper horizontal part 136b extended from one edge of the vertical part 136a in the inner radial direction to support an upper surface of the coil 132, and a lower horizontal part 136c extended from the other edge of the vertical part 136a in the inner radial direction to support a lower surface of the coil 132.

An outer peripheral surface of the vertical part 136a may contact the mass body 134 to fixedly support the mass body 134, and an inner peripheral surface of the vertical part 136a, the upper horizontal part 136b, and the lower horizontal part 136c may contact the coil 132 to fixedly support the coil 132.

In addition, the holder 136 may be formed of a material including iron, nickel, cobalt, or the like, more specifically, a magnetic material.

However, the holder 136 is not limited to being formed of the material including the iron, the nickel, the cobalt, or the like, but may be formed of any material having magnetism.

In the case in which the holder 136 is formed of a magnetic material, a magnetic field may be concentrated on the coil 132. Therefore, an electromagnetic damping effect may be implemented.

Therefore, a magnetic fluid may not be applied between the magnet 122 and the coil 132.

In addition, an effect of increasing electromagnetic force may be accomplished. Therefore, a response speed of the linear vibrator according to the embodiment of the present invention may be improved and vibration force may be improved.

Further, the vertical part 136a of the holder 136 may be formed to be higher than lower surfaces of the coil 132 and the mass body 134 so as to form a space between the coil 132 and the mass body 134, and the space may be filled with an adhesive (not shown) to allow the coil 132 and the mass body 134 to be more firmly coupled to each other.

FIG. 4 is a cross-sectional perspective view of a holder provided in the linear vibrator according to another embodiment of the present invention.

Referring to FIG. 4, the linear vibrator according to another embodiment of the present invention is the same as the linear vibrator according to the above-described embodiment of the present invention, except for a holder 236. Therefore, a description of components thereof, except for the holder 236, will be omitted.

The holder 236 may include a cylindrical vertical part 236a contacting one surfaces of the coil 132 and the mass body 134, an upper horizontal part 236b extended from one edge of the vertical part 236a in the inner radial direction and the outer radial direction to support an upper surface of the coil 132 and an upper surface of the mass body 134, and a lower horizontal part 236c extended from the other edge of the vertical part 236a in the inner radial direction and the outer radial direction to support a lower surface of the coil 132 and a lower surface of the mass body 134.

An outer peripheral surface of the vertical part 236a may contact the mass body 134 to fixedly support the mass body 134, and an inner peripheral surface of the vertical part 236a may contact the coil 132 to fixedly support the coil 132.

In addition, the upper horizontal part 236b may contact the upper surface of the coil 132 and the upper surface of the mass body 134, and the lower horizontal part 236c may contact the lower surface of the coil 132 and the lower surface of the mass body 134 to fixedly support the coil 132 and the mass body 134.

The holder 236 may be provided as a single member or be provided as two members, that is, upper and lower members, combined with each other.

In addition, the holder 236 may be formed of a material including iron, nickel, cobalt, or the like, and more specifically, a magnetic material.

However, the holder 236 is not limited to being formed of the material including iron, nickel, cobalt, or the like, but may also formed of any material having magnetism.

In the case in which the holder 236 is formed of a magnetic material, a magnetic field may be concentrated on the coil 132. Therefore, an electromagnetic damping effect maybe implemented.

Therefore, a magnetic fluid may not be applied between the magnet 122 and the coil 132.

In addition, an effect of increasing electromagnetic force may be accomplished. Therefore, a response speed of the linear vibrator according to the embodiment of the present invention may be improved and vibration force may be improved.

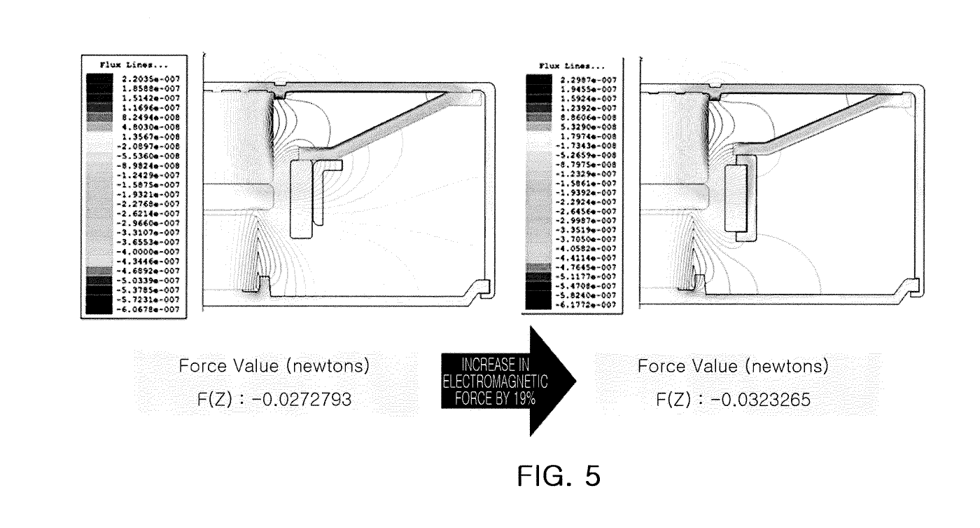

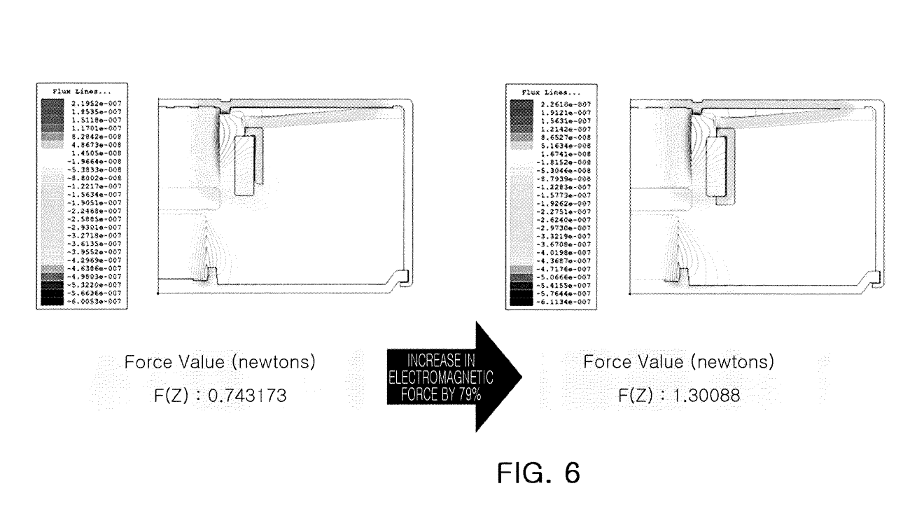

FIGS. 5 and 6 are cross-sectional views showing an increase in electromagnetic force of a linear vibrator according to an embodiment of the present invention.

Referring to FIG. 5, it could be appreciated that a structure in which one edge and the other edge of the holder are extended in the inner radial direction, like the holder 136 according to the embodiment of the present invention, has electromagnetic force increased as compared with a structure in which one edge of the holder is extended in the outer radial direction by 19%.

Referring to FIG. 6, it could be appreciated that a structure in which one edge and the other edge of the holder are extended in the inner radial direction, like the holder 136 according to the embodiment of the present invention, has electromagnetic force increased as compared with a structure in which only one edge of the holder is extended in the inner radial direction by 75%.

According to the above-mentioned embodiment of the present invention, one edge and the other edge of the holder 136 or 236 are extended in the inner radial direction, such that an increase in electromagnetic force may be achieved. Therefore, the response speed may be improved.

In addition, an electromagnetic damping effect may be obtained without applying the magnetic fluid.

As set forth above, in a linear vibrator according to embodiments of the present invention, electromagnetic force may be increased to thereby improve a response speed, and an electromagnetic damping effect may be implemented.

While the present invention has been shown and described in connection with the embodiments, it will be apparent to those skilled in the art that modifications and variations can be made without departing from the spirit and scope of the invention as defined by the appended claims.

What is claimed is:

1. A linear vibrator comprising:
a fixed part having an internal space of a predetermined size provided therein;
a magnet coupled to one surface of the internal space of the fixed part and generating magnetic force;
a vibrating part including a coil disposed to face the magnet and interacting with the magnet to generate electromagnetic force and a mass body vibrated by the electromagnetic force; and
a holder provided between the coil and the mass body and having one edge and the other edge extended in an inner radial direction.

2. The linear vibrator of claim 1, wherein the holder includes:
a cylindrical vertical part contacting one surfaces of the coil and the mass body;
an upper horizontal part extended from one edge of the vertical part in the inner radial direction; and
a lower horizontal part extended from the other edge of the vertical part in the inner radial direction.

3. The linear vibrator of claim 2, wherein the upper horizontal part contacts an upper surface of the coil, and
the lower horizontal part contacts a lower surface of the coil.

4. The linear vibrator of claim 1, further comprising a yoke plate coupled to a lower surface of the magnet and smoothing magnetic flux flowing to the magnet.

5. The linear vibrator of claim 1, wherein one surface of the internal space of the fixed part is provided with an outer wall protruding therefrom so as to correspond to an outer diameter of the magnet.

6. The linear vibrator of claim 1, further comprising a magnetic body coupled to the other surface of the internal space of the fixed part.

7. The linear vibrator of claim 6, wherein the other surface of the internal space of the fixed part is provided with a protrusion part protruding therefrom so as to correspond to an outer diameter of the magnetic body.

8. The linear vibrator of claim 1, wherein the holder is formed of a magnetic material.

9. A linear vibrator comprising:
a fixed part having an internal space of a predetermined size provided therein;
a magnet coupled to one surface of the internal space of the fixed part and generating magnetic force;
a vibrating part including a coil disposed to face the magnet and interacting with the magnet to generate electromagnetic force and a mass body vibrated by the electromagnetic force; and
a holder provided between the coil and the mass body and having one edge and the other edge extended in an inner radial direction and an outer radial direction.

10. The linear vibrator of claim 9, wherein the holder includes:
a cylindrical vertical part contacting one surfaces of the coil and the mass body;
an upper horizontal part extended from one edge of the vertical part in the inner radial direction and the outer radial direction; and
a lower horizontal part extended from the other edge of the vertical part in the inner radial direction and the outer radial direction.

11. The linear vibrator of claim 9, wherein the upper horizontal part contacts an upper surface of the coil and an upper surface of the mass body, and
the lower horizontal part contacts a lower surface of the coil and a lower surface of the mass body.

12. The linear vibrator of claim 9, wherein the holder is formed of a magnetic material.
